(19) United States
(12) Patent Application Publication
(10) Pub. No.: US 2026/0324864 A1
(43) Pub. Date: Oct. 22, 2026

(54) ANGLE ADJUSTMENT MECHANISM AND MASSAGE CHAIR

(71) Applicants: ZHEJIANG SHUYUE SUPPLY CHAIN CO., LTD., WENZHOU CITY (CN); HEFEI MORNINGSTAR HEALTHMATE FITNESS CO., LTD., HEFEI CITY (CN)

(72) Inventors: MEISHEN JIN, WENZHOU CITY (CN); ZERUI HONG, WENZHOU CITY (CN)

(21) Appl. No.: 19/182,647

(22) Filed: Apr. 18, 2025

(51) Int. Cl. A47C 1/032; A61H 15/00

(52) U.S. Cl. CPC A47C 1/032; A61H 15/0078; A61H 2015/0014; A61H 2201/0149; A61H 2201/0192; A61H 2201/123; A61H 2201/149; A61H 2201/1623; A61H 2201/1671; A61H 2203/0425

(57) ABSTRACT

An angle adjustment mechanism includes a base frame assembly. A reclining assembly is rotatably mounted on the base frame assembly, and a backrest assembly is further rotatably mounted on the reclining assembly. The mechanism further includes a first electric push rod and a second electric push rod. The first electric push rod is rotatably mounted on the reclining assembly, and a telescopic rod of the first electric push rod is rotatably mounted on the base frame assembly. The second electric push rod is rotatably mounted on the reclining assembly, and a telescopic rod of the second electric push rod is rotatably mounted on the backrest assembly. The first electric push rod is configured to drive the reclining assembly to rotate relative to the base frame assembly, while the second electric push rod is configured to drive the backrest assembly to rotate relative to the reclining assembly.

### FIELD OF THE DISCLOSURE

The present disclosure relates to the field of angle adjustment structures for massage chairs, specifically to an adjustment mechanism and a massage chair.

### BACKGROUND OF THE DISCLOSURE

A massage chair utilizes mechanical rolling force and mechanical pressure to perform massage functions. During a massage, the massage chair typically rotates the backrest frame to allow the user to recline into a lying position and then rotates it back to its original position at the end of the massage. However, although conventional massage chairs can rotate the backrest frame back to its original position, the seat surface often remains inclined relative to the horizontal plane after reset. For elderly users or individuals with mobility impairments, this seat inclination angle presents a challenge when attempting to stand up, requiring them to overcome the seat angle. They often need to grip the armrests to apply additional external force to assist in standing. As a result, in existing massage chairs, the backrest frame cannot continue rotating after resetting to further assist users in standing up.

### SUMMARY OF THE DISCLOSURE

In view of the shortcomings in the prior art, the present disclosure provides an adjustment mechanism and a massage chair, addressing the issue that in existing massage chairs, the backrest frame cannot continue rotating after resetting to assist users in standing up.

To achieve the above objective, the present disclosure adopts the following technical solution.

An angle adjustment mechanism is provided, including: a reclining assembly and a backrest assembly rotatably mounted on the reclining assembly, wherein a second electric push rod is rotatably mounted on the reclining assembly, and a telescopic rod of the second electric push rod is rotatably mounted on the backrest assembly; and wherein the second electric push rod is configured to drive the backrest assembly to rotate relative to the reclining assembly.

Optionally, the backrest assembly includes two curved positioning tracks that are arranged parallel to each other and a backrest frame correspondingly mounted on the two curved positioning tracks; and wherein front ends of the two curved positioning tracks are correspondingly and fixedly connected to a connecting tube, and a rotating shaft that is outwardly extending and rotatably mounted on the reclining assembly is correspondingly provided on two ends of the connecting tube.

Optionally, at least one second bent tube that is in a U-shaped configuration is installed between the two curved positioning tracks and the telescopic rod of the second electric push rod is rotatably connected to the second bent tube that is the lowest-positioned.

Optionally, a surface of the backrest frame has a curved structure that is approximately L-shaped, and a slot passing through the curved surface structure is provided on the backrest frame.

Optionally, the reclining assembly includes a second bracket and two arcuate tracks that are symmetrically arranged with each other and mounted on the second bracket.

Optionally, a first bent tube that is in a U-shaped configuration is connected between the two arcuate tracks.

The angle adjustment mechanism further includes a base frame assembly, the reclining assembly is slidably mounted on the base frame assembly, a first electric push rod is rotatably mounted on the reclining assembly, a telescopic rod of the first electric push rod is rotatably mounted on the base frame assembly, and the first electric push rod is configured to drive the reclining assembly to slide relative to the base frame assembly.

Optionally, the base frame assembly includes a first bracket and two support frames that are symmetrically arranged with each other and mounted on the first bracket, two rotating guide wheels that are spaced with each other are provided on each of two side surfaces of the two support frames that face each other, and the arcuate track corresponding to each of the side surfaces that face each other is slidably engaged with the two rotating guide wheels; and wherein the telescopic rod of the first electric push rod is rotatably mounted at an end of the first bracket.

Optionally, a reinforcing connecting rod is provided between the two support frames, an oblique support rod is correspondingly arranged between each of the two support frames and the first bracket, and a guide roller is provided at an end of the first bracket.

The present disclosure further provides a massage chair, which includes the angle adjustment mechanism as mentioned above.

The advantages of the present disclosure over the prior art are as follows.

When the backrest assembly resets after use, the second electric push rod is configured to drive the backrest assembly to rotate relative to the reclining assembly. This action further pushes the user forward, enabling the user's body to continue leaning forward, thereby facilitating standing up. This eliminates the need for the user to manually pull on the armrests to get up. Particularly for elderly users or individuals with mobility impairments, the provision of active thrust assists in standing up, significantly enhancing the user experience.

### BRIEF DESCRIPTION OF THE DRAWINGS

FIG. 1 is a schematic structural diagram of a first perspective view of an embodiment of the present disclosure;

FIG. 2 is a schematic structural diagram of a second perspective view of an embodiment of the present disclosure;

FIG. 3 is a schematic structural diagram of a backrest assembly in the present disclosure;

FIG. 4 is a schematic structural diagram of a reclining assembly in the present disclosure; and

FIG. 5 is a schematic structural diagram of a base frame in the present disclosure.

Reference numeral: 1, Base frame assembly; 2, Reclining assembly; 3, Backrest assembly; 4, First electric push rod; 5, Second electric push rod; 6, First bracket; 7, Support frame; 8, Rotating guide wheel; 9, Reinforcing connecting rod; 10, Oblique support rod; 11, Guide roller; 12, Second bracket; 13, Arcuate track; 14, First bent tube; 15, Curved positioning track; 16, Backrest frame; 17, Connecting tube; 18, Rotating shaft; 19, Second bent tube.

### DETAILED DESCRIPTION OF THE EXEMPLARY EMBODIMENTS

The present disclosure is further described below in conjunction with the accompanying drawings and specific embodiments to enable those skilled in the art to better understand and implement the present disclosure. However, the cited embodiments are not intended to limit the present disclosure.

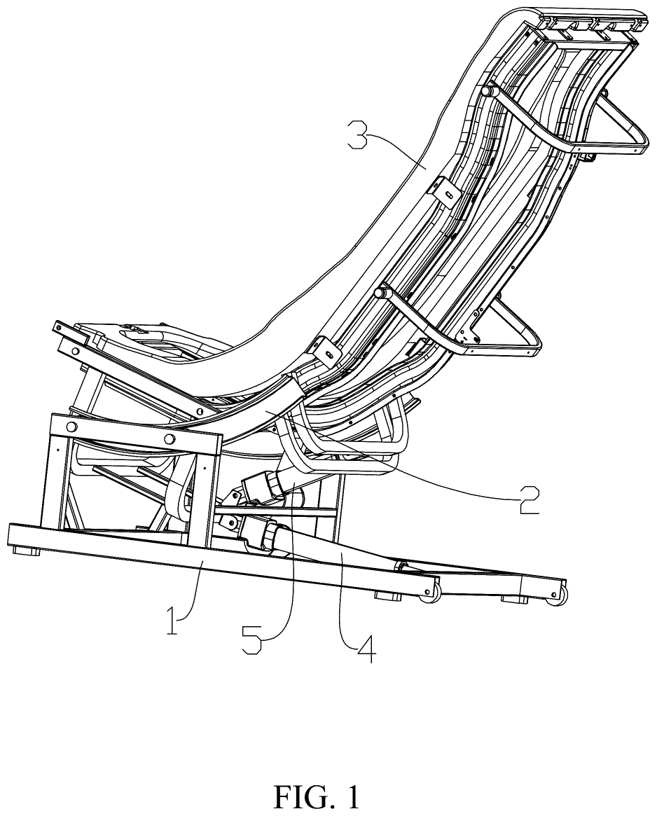

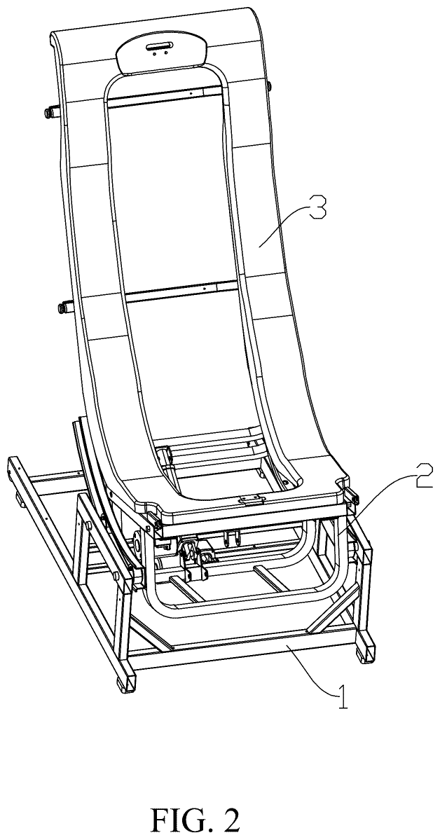

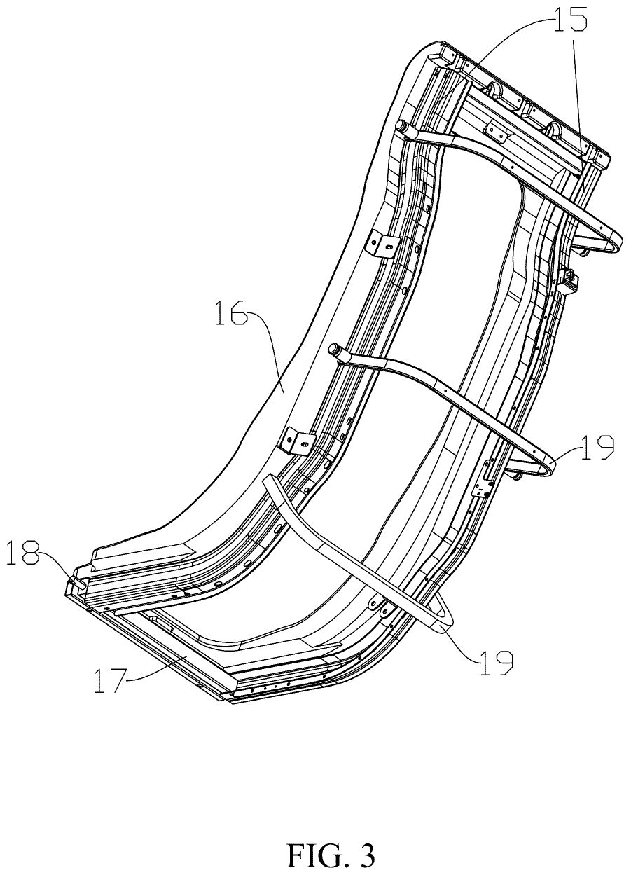

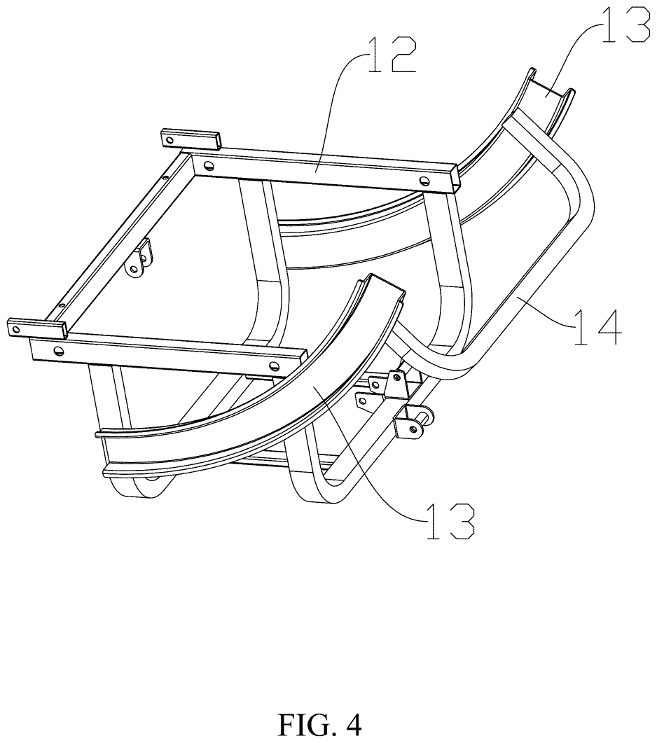

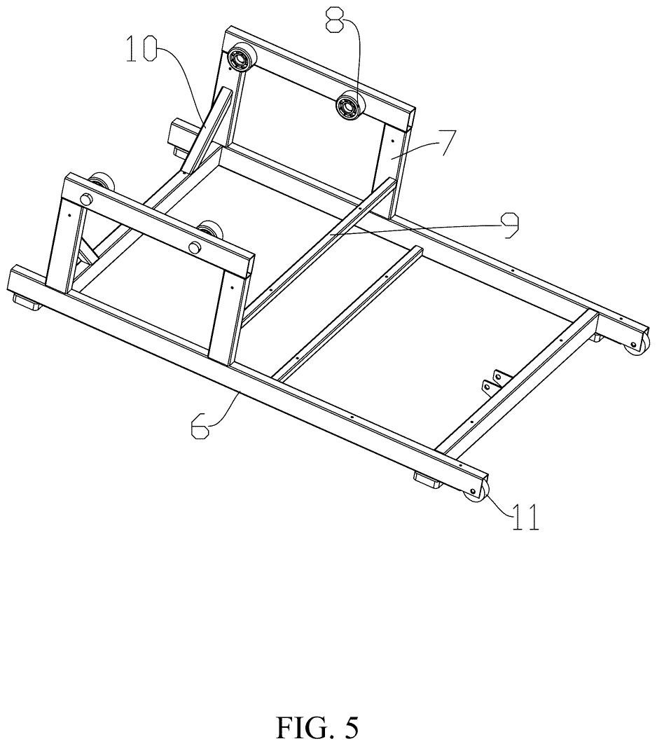

As shown in FIG. 1 to FIG. 5, an embodiment of the present disclosure provides an angle adjustment mechanism. The entire angle adjustment structure is installed in a massage chair to adjust an angle of a backrest portion. The angle adjustment mechanism includes a base frame assembly 1, a reclining assembly 2 is slidably mounted on the base frame assembly 1, and a backrest assembly 3 is further rotatably mounted on the reclining assembly 2. Additionally, the angle adjustment mechanism includes a first electric push rod 4 and a second electric push rod 5, the first electric push rod 4 is rotatably mounted on the reclining assembly 2, and a telescopic rod of the first electric push rod 4 is rotatably mounted on the base frame assembly 1. The second electric push rod 5 is rotatably mounted on the reclining assembly 2, and a telescopic rod of the second electric push rod 5 is rotatably mounted on the backrest assembly 3. By driving the reclining assembly 2 to rotate relative to the base frame assembly 1 through the first electric push rod 4, the reclining assembly 2, along with the backrest assembly 3, rotates to form an angle adjustment between a reclining state and an inclined state. However, in a reset state, an inclination angle of the backrest assembly 3 is not sufficient to push the user's body into a position where they can directly stand up. At this point, the second electric push rod 5 is configured to drive the backrest assembly 3 to rotate relative to the reclining assembly 2, further pushing the user's body forward and facilitating the user's back to lean forward to achieve standing up.

Specifically, the base frame assembly 1 includes a first bracket 6 and two support frames 7 that are symmetrically arranged with each other and mounted on the first bracket 6. Each of side surfaces of the support frames 7 that face each other are provided with two rotating guide wheels 8 that are spaced with each other. A function of the rotating guide wheels 8 is to support the reclining assembly 2 while allowing the reclining assembly 2 to slide relative to the rotating guide wheels 8 and achieve angle adjustment. The telescopic rod of the first electric push rod 4 is rotatably mounted at an end of the first bracket 6, thereby enabling the first electric push rod 4 to push the reclining assembly 2 to achieve an arc-shaped angle rotation.

To enhance a connection strength between the two support frames 7, a reinforcing connecting rod 9 is provided between the two support frames 7, and an oblique support rod 10 is correspondingly provided between each of the two support frames 7 and the first bracket 6.

Additionally, a guide roller 11 is provided at an end of the first bracket 6, so as to facilitate relative position guidance of the base frame assembly 1 when being installed in the massage chair.

Specifically, the reclining assembly 2 includes a second bracket 12 and two arcuate tracks 13 that are symmetrically arranged with each other and mounted on the second bracket 12. The arcuate tracks 13 on the corresponding sides are slidably engaged with the two rotating guide wheels 8. By forming sliding engagement between the arcuate tracks 13 and the rotating guide wheels 8, the reclining assembly 2 is able to rotate along an arc, allowing adjustment of the backrest assembly 3 to a reclining state.

To ensure a connection strength between the two arcuate tracks 13, a first bent tube 14 that is in a U-shaped configuration is connected between the two arcuate tracks 13, so as to further enhance the structural stability of the installation between the two arcuate tracks 13.

Specifically, the backrest assembly 3 includes two curved positioning tracks 15 that are arranged parallel to each other and a backrest frame 16 correspondingly mounted on the two curved positioning tracks 15. The backrest frame 16 is integrally formed by injection molding and is installed at a back of the massage mechanism to support the seat cushion and massage components, while the two curved positioning tracks 15 provide structural support and connection to the massage mechanism. A connecting tube 17 is correspondingly and fixedly connected to front ends of the two curved positioning tracks 15, and both ends of the connecting tube 17 extend outward and are rotatably mounted on the second bracket 12 via rotating shafts 18. After the backrest frame 16 is rotatably mounted on the second bracket 12 via the rotating shafts 18, the second electric push rod 5 can drive the backrest frame 16 to continue rotating forward, pushing the user's body forward to facilitate standing up. A second bent tube 19 that is in a U-shaped configuration is installed between the two curved positioning tracks 15, and multiple second bent tubes 19 can be provided to further reinforce the structural stability of the entire backrest assembly 3.

Specifically, the telescopic rod of the second electric push rod 5 is rotatably connected to the second bent tube 19 that is lowest-positioned, so as to enable a faster response when driving the entire backrest assembly 3 to rotate. Meanwhile, a surface of the backrest frame 16 adopts an approximately L-shaped curved structure, which conforms to ergonomic requirements to better accommodate the user's back. Additionally, the backrest frame 16 is provided with a slot passing through the curved surface structure, thereby facilitating the installation of the back massage mechanism and allowing exposure for performing massage actions on the back area.

Based on the above embodiment, a massage chair is further provided, wherein the angle adjustment mechanism is installed within the massage chair, which allows for reclining angle adjustments and resetting while further assisting in pushing the user's body forward to facilitate quick standing.

In the description of the present disclosure, it should be understood that the terms indicating directions or positional relationships are based on the orientations or positional relationships shown in the accompanying drawings. These are merely for convenience in describing the present disclosure and simplifying the description, rather than indicating or implying that the referenced equipment or components must have specific orientations, be constructed, or operate in a specific manner. Therefore, these descriptions should not be considered as limitations on the present disclosure.

In the present disclosure, unless explicitly stated otherwise, the terms “installation,” “connection,” “attachment,” and “fixation” should be interpreted broadly. For example, they may refer to fixed connections, detachable connections, or integral formations; they may indicate mechanical connections or electrical connections; they may refer to direct connections or indirect connections via an intermediary medium; or they may describe internal communication within components or the interaction between two elements. A person skilled in the art can determine the specific meaning of these terms within the context of the present disclosure based on specific circumstances.

In the description of the present disclosure, it should also be noted that terms such as “center,” “upper,” “lower,” “left,” “right,” “inner,” and “outer” indicate relative positions based on the orientations or positional relationships shown in the accompanying drawings, or conventional placement positions when the product is in use. These are merely for convenience in describing the present disclosure and simplifying the description, and should not be construed as requiring that the described devices or components must have specific orientations, be configured, or operate in a specific way. Furthermore, terms such as “first” and “second” are used solely for distinction and should not be interpreted as indicating relative importance.

Finally, it is to be noted that the above-described embodiments are provided merely to illustrate the technical solutions of the present disclosure and are not intended to limit it. Although the present disclosure has been described in detail with reference to preferred embodiments, those skilled in the art should understand that modifications or equivalent replacements may be made to the technical solutions of the present disclosure without departing from its spirit and scope, which should be encompassed within the claims of the present disclosure.

What is claimed is:

1. An angle adjustment mechanism, comprising: a reclining assembly (2) and a backrest assembly (3) rotatably mounted on the reclining assembly (2), wherein a second electric push rod (5) is rotatably mounted on the reclining assembly (2), and a telescopic rod of the second electric push rod (5) is rotatably mounted on the backrest assembly (3); and
wherein the second electric push rod (5) is configured to drive the backrest assembly (3) to rotate relative to the reclining assembly (2).

2. The angle adjustment mechanism according to claim 1, wherein the backrest assembly (3) includes two curved positioning tracks (15) that are arranged parallel to each other and a backrest frame (16) correspondingly mounted on the two curved positioning tracks (15); and
wherein front ends of the two curved positioning tracks (15) are correspondingly and fixedly connected to a connecting tube (17), and a rotating shaft (18) that is outwardly extending and rotatably mounted on the reclining assembly (2) is correspondingly provided on two ends of the connecting tube (17).

3. The angle adjustment mechanism according to claim 2, wherein at least one second bent tube (19) that is in a U-shaped configuration is installed between the two curved positioning tracks (15) and the telescopic rod of the second electric push rod (5) is rotatably connected to the second bent tube (19) that is the lowest-positioned.

4. The angle adjustment mechanism according to claim 3, wherein a surface of the backrest frame (16) has a curved structure that is approximately L-shaped, and a slot passing through the curved surface structure is provided on the backrest frame (16).

5. The angle adjustment mechanism according to claim 2, wherein the reclining assembly (2) includes a second bracket (12) and two arcuate tracks (13) that are symmetrically arranged with each other and mounted on the second bracket (12).

6. The angle adjustment mechanism according to claim 5, wherein a first bent tube (14) that is in a U-shaped configuration is connected between the two arcuate tracks (13).

7. The angle adjustment mechanism according to claim 6, further comprising a base frame assembly (1), wherein the reclining assembly (2) is slidably mounted on the base frame assembly (1), a first electric push rod (4) is rotatably mounted on the reclining assembly (2), a telescopic rod of the first electric push rod (4) is rotatably mounted on the base frame assembly (1), and the first electric push rod (4) is configured to drive the reclining assembly (2) to slide relative to the base frame assembly (1).

8. The angle adjustment mechanism according to claim 7, wherein the base frame assembly (1) includes a first bracket (6) and two support frames (7) that are symmetrically arranged with each other and mounted on the first bracket (6), two rotating guide wheels (8) that are spaced with each other are provided on each of side surfaces of the two support frames (7) that face each other, and the arcuate track (13) corresponding to each of the side surface of the two support frames (7) that face each other is slidably engaged with the two rotating guide wheels (8); and
wherein the telescopic rod of the first electric push rod (4) is rotatably mounted at an end of the first bracket (6).

9. The angle adjustment mechanism according to claim 8, wherein a reinforcing connecting rod (9) is provided between the two support frames (7), an oblique support rod (10) is correspondingly provided between each of the two support frames (7) and the first bracket (6), and a guide roller (11) is provided at an end of the first bracket (6).

10. A massage chair, comprising: the angle adjustment mechanism according to claim 1.
